(19) United States
(12) Patent Application Publication
(10) Pub. No.: US 2025/0293568 A1
(43) Pub. Date: Sep. 18, 2025

(54) INTEGRATED ELECTRIC PUMP AND VEHICLE

(71) Applicant: WEICHAI POWER CO., LTD., Shandong (CN)

(72) Inventors: Damir Adelshin, Shandong (CN); Lukas Krittian, Shandong (CN); Tobias Lange, Shandong (CN); Hongliu DU, Shandong (CN)

(21) Appl. No.: 19/039,910

(22) Filed: Jan. 29, 2025

(30) Foreign Application Priority Data
Mar. 18, 2024 (CN) 202410303110.9

(51) Int. Cl. H02K 7/14; F04B 17/03; F04B 19/22; H02K 5/16; H02K 5/20; H02K 7/00; H02K 7/08; H02K 9/193

(52) U.S. Cl. CPC H02K 7/14; F04B 17/03; F04B 19/22; H02K 5/161; H02K 5/203; H02K 7/003; H02K 7/083; H02K 9/193

(57) ABSTRACT

An integrated electric pump includes an electric machine, a pump, multiple spray nozzles, and an oil discharge pump. The electric machine and the pump are integrated. The electric machine includes a machine housing, a stator, a rotor, and a rotor shaft. The stator is fixedly disposed in the machine housing. The rotor shaft is rotatably disposed in the machine housing. The rotor is fixedly disposed on the rotor shaft. The stator is sleeved on the rotor with a gap between the stator and the rotor. The rotor shaft is provided with a first cooling oil circuit. The machine housing is provided with a second cooling oil circuit. The rotor shaft is drivingly connected to the pump. The spray nozzles are connected to the second cooling oil circuit

### CROSS-REFERENCE TO RELATED APPLICATION(S)

This application claims priority to Chinese Patent Application No. 202410303110.9 filed Mar. 18, 2024, the disclosure of which is incorporated herein by reference in its entirety.

### TECHNICAL FIELD

The present disclosure relates to the technical field of vehicles and, in particular, to an integrated electric pump and a vehicle.

### BACKGROUND

Diesel engines have traditionally been the main power source for heavy vehicles due to the high torque output and reliability. However, it is well known that diesel engines produce a large number of harmful emissions such as particulate matter, nitrogen oxides, and carbon dioxide. These emissions lead to environmental pollution, climate change, and public health problems. In response to this, in the related art, battery-driven electric machines are used as substitutes for diesel engines and applied to vehicles to improve energy efficiency, reduce emissions, and improve performance.

For example, in the related art, a piston electro-hydraulic pump (CN106089624A) is provided in which the rotor of the electric machine and the piston cylinder are structurally connected together to convert the rotational motion into the linear motion of the piston. In this manner, the structure of the hydraulic power unit can be greatly simplified, the motion conversion device can be eliminated, and the stator and the rotor of the electric machine are both immersed in oil to cool the electric machine. However, viscous friction losses of the rotor of the electric machine are inevitably generated during operation, resulting in low efficiency and higher sealing requirements for the machine housing.

In response to this, a previous patent with an application number of CN201310025743.X discloses an air-gap non-oil-immersed hydraulic motor vane pump. In this solution, the rotor shaft of the electric machine is provided with a cooling channel, and the machine housing is provided with a cooling jacket, thereby cooling the rotor and the stator of the electric machine, respectively. In this manner, the stator and the rotor of the electric machine can be prevented from being immersed in oil, the efficiency can be improved, and the sealing requirements for the machine housing can be lowered. However, the rotor shaft and the machine housing are needed for the oil to exchange heat with the rotor and the stator, and the oil cannot be in direct contact with the rotor and the stator, affecting the cooling effect to a certain extent and affecting the maximum operating power of the electric machine.

### SUMMARY

The present disclosure provides an integrated electric pump and a vehicle to solve the following problem in the related art: the rotor shaft of an electric machine is provided with a cooling channel, and a machine housing is provided with a cooling jacket, thereby cooling the rotor and the stator of the electric machine, respectively; but the oil cannot be in direct contact with the rotor and the stator, affecting the cooling effect to a certain extent and affecting the maximum operating power of the electric machine.

On the one hand, the present disclosure provides an integrated electric pump. The integrated electric pump includes an electric machine and pumps. The electric machine and the pumps are integrated. The electric machine includes a machine housing, a stator, a rotor, and a rotor shaft. The machine housing has having an inner cavity. The stator, the rotor, and the rotor shaft are disposed in the inner cavity, the stator is fixedly disposed in the machine housing, the rotor shaft is rotatably disposed in the machine housing, the rotor is fixedly disposed on the rotor shaft, the stator is sleeved on the rotor with a gap between the stator and the rotor, the rotor shaft is provided with a first cooling oil circuit, the machine housing is provided with a second cooling oil circuit, and the rotor shaft is drivingly connected to the pumps. The integrated electric pump further includes multiple spray nozzles and an oil discharge pump.

The multiple spray nozzles are fixed to the machine housing, where the multiple spray nozzles are connected to the second cooling oil circuit and are used for spraying cooling oil to the stator.

The oil discharge pump is used for discharging the cooling oil in the inner cavity out of the inner cavity.

As a preferred technical solution of the integrated electric pump, the machine housing is further provided with an oil collection tank, the oil discharge pump is connected to the oil collection tank, the oil collection tank is connected to the inner cavity, and the connection point between the oil connection tank and the inner cavity is located at the lowest point of the inner cavity.

As a preferred technical solution of the integrated electric pump, the integrated electric pump further includes multiple gas jet nozzles which are disposed in the machine housing, connected to the inner cavity, and used for spraying compressed gas into the inner cavity.

As a preferred technical solution of the integrated electric pump, the integrated electric pump further includes a first bearing and a second bearing arranged at intervals, where the inner race of the first bearing and the inner race of the second bearing are fixedly sleeved on two ends of the rotor shaft, respectively, and the outer race of the first bearing and the outer race of the second bearing are both fixedly disposed in the machine housing.

As a preferred technical solution of the integrated electric pump, the pump is a piston pump, and the piston pump includes a pump housing, a cylinder body, a pump shaft, multiple first pistons, and a second piston.

The pump housing is fixedly disposed on the machine housing.

The cylinder body is rotatably disposed in the pump housing, where the cylinder body is provided with multiple piston chambers.

The pump shaft includes a connection end and a connecting shaft fixedly connected to the connection end, where the connecting shaft is rotatably disposed in the machine housing, and the connecting shaft and the rotor shaft are splined.

The multiple first pistons are slidably disposed in the multiple piston chambers in one-to-one correspondence, where a first ball head is disposed at an end of the first piston and spherically hinged with the connection end.

The multiple first pistons are evenly distributed along the circumferential direction of the second piston, a second ball head is provided at an end of the second piston and spherically hinged with the connection end, and the centerline of the second piston is disposed at an included angle to the centerline of the pump shaft.

As a preferred technical solution of the integrated electric pump, the piston pump further includes a third bearing, where the first bearing is located between the third bearing and the second bearing, and the inner race of the third bearing is fixedly sleeved on the connecting shaft.

The machine housing includes a cylindrical housing in a tubular shape, a first end housing, and a second end housing, the first end housing and the second end housing are connected to two ends of the cylindrical housing, the cylindrical housing, the first end housing, and the second end housing enclose to form the inner cavity, the connecting shaft is rotatably disposed in the first end housing, the outer race of the first bearing and the outer race of the third bearing are both fixedly disposed in the first end housing, and the outer race of the second bearing is fixedly disposed in the second end housing.

As a preferred technical solution of the integrated electric pump, the rotor shaft is provided with a spline groove, the connecting shaft is provided with spline teeth, the spline teeth are inserted into the spline groove, and the first bearing is also sleeved on the connecting shaft.

As a preferred technical solution of the integrated electric pump, the piston pump further includes a shaft seal located between the first bearing and the third bearing, the shaft seal is sleeved on the connecting shaft and sealingly mates with the connecting shaft, the shaft seal is in sealing contact with the machine housing, a first oil chamber is formed between the shaft seal and the first bearing, and a second oil chamber is formed between the shaft seal and the third bearing.

As a preferred technical solution of the integrated electric pump, the piston pump is further provided with an oil inlet circuit passing through the pump housing, the cylinder body, the second piston, and the pump shaft in sequence and connected to an end of the first cooling oil circuit.

As a preferred technical solution of the integrated electric pump, the connecting shaft is further provided with a first lubricating oil circuit connected to the oil inlet circuit, and the first lubricating oil circuit is connected to the first oil chamber.

As a preferred technical solution of the integrated electric pump, the connecting shaft is further provided with a second lubricating oil circuit connected to the oil inlet circuit, and the second lubricating oil circuit is connected to the second oil chamber.

As a preferred technical solution of the integrated electric pump, the integrated electric pump includes two piston pumps disposed at two ends of the electric machine, respectively, where the two ends of the rotor shaft are splined to connecting shafts of the two piston pumps, respectively, and at least one piston pump is provided with the oil inlet circuit.

As a preferred technical solution of the integrated electric pump, the electric machine is rotatable in the forward direction and the reverse direction.

On the other hand, the present disclosure provides a vehicle. The vehicle includes the integrated electric pump in any of the preceding solutions, where the integrated electric pump and a hydraulic motor or hydraulic cylinder of the vehicle form a closed hydraulic system loop.

In the present disclosure, the integrated electric pump includes the electric machine and the pumps, and the electric machine and the pumps are integrated. On the one hand, the rotor shaft of the electric machine is provided with the first cooling oil circuit, and the machine housing of the electric machine is provided with the second cooling oil circuit so that heat may be exchanged between the cooling oil in the first cooling oil circuit and the rotor shaft, and then heat may be exchanged between the rotor shaft and the rotor, thereby lowering the temperature of the rotor;

and heat may be exchanged between the cooling oil in the second cooling oil circuit and the machine housing, and then heat may be exchanged between the machine housing and the stator, thereby lowering the temperature of the stator. On the other hand, multiple spray nozzles may be provided in the machine housing of the electric machine, the spray nozzles are connected to the second cooling oil circuit and are used for spraying cooling oil to the stator to significantly lower the temperature of the stator, and the cooling oil can be in contact with the air in the inner cavity to reduce the temperature inside the inner cavity, thereby significantly improving the capacity of cooling the electric machine and ensuring the output power of the electric machine. Moreover, the oil discharge pump discharges the cooling oil in the inner cavity out of the inner cavity so that the cooling oil can be prevented from accumulating in the inner cavity, it can be ensured that the air gap between the rotor and the stator is filled with air, the power loss of the rotation of the rotor can be reduced or eliminated, and the sealing requirements for the machine housing can be lowered.

In the present disclosure, the vehicle includes the preceding integrated electric pump, the pump is a piston pump, the integrated electric pump and a hydraulic motor of the vehicle form a closed hydraulic system loop, and the integrated electric pump of the vehicle has a better cooling effect and can ensure higher operating power.

### BRIEF DESCRIPTION OF DRAWINGS

FIG. 1 is view one illustrating the structure of an integrated electric pump according to an embodiment of the present disclosure.

FIG. 2 is view two illustrating the structure of an integrated electric pump according to an embodiment of the present disclosure.

FIG. 3 is view one illustrating some structures of an integrated electric pump according to an embodiment of the present disclosure.

FIG. 4 is view two illustrating some structures of an integrated electric pump according to an embodiment of the present disclosure.

### REFERENCE LIST

100 electric machine
200 piston pump
1 machine housing
101 cylindrical housing
1011 oil collection tank
102 first end housing
103 second end housing
104 inner cavity
105 second cooling oil circuit
1051 cooling jacket oil circuit
1052 first oil spraying circuit
1053 second oil spraying circuit
106 spray nozzle
107 gas jet nozzle
108 oil input port
2 stator
201 stator body
202 stator winding
3 rotor
4 rotor shaft
5 first cooling oil circuit
6 first bearing
7 second bearing
8 pump housing
801 pump inlet oil circuit
802 pump outlet oil circuit
9 pump shaft
901 connection end
902 connecting shaft
903 first lubricating oil circuit
904 second lubricating oil circuit
10 cylinder body
1001 piston chamber
11 first piston
12 second piston
13 oil inlet circuit
14 third housing
15 shaft seal
16 first oil chamber
17 second oil chamber
18 oil discharge pump

### DETAILED DESCRIPTION

The technical solutions of the present disclosure are described clearly and completely hereinafter in conjunction with drawings. Apparently, the described embodiments are part, not all, of embodiments of the present disclosure. Based on the embodiments of the present disclosure, all other embodiments obtained by those of ordinary skill in the art without creative work are within the scope of the present disclosure.

In the description of the present disclosure, it is to be noted that orientations or position relations indicated by terms such as “center”, “upper”, “lower”, “left”, “right”, “vertical”, “horizontal”, “inner”, and “outer” are based on the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. Additionally, terms such as “first” and “second” are used only for the purpose of description and are not to be construed as indicating or implying relative importance. Terms “first position” and “second position” are two different positions. Moreover, when a first feature is described as “on”, “above”, or “over” a second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of the present disclosure, it is to be noted that the term “mounted”, “connected to each other”, or “connected” should be construed in a broad sense unless otherwise expressly specified and limited. For example, the term “connected” may refer to “fixedly connected”, “detachably connected”, or “integrated”, may refer to “mechanically connected” or “electrically connected”, or may refer to “connected directly”, “connected indirectly through an intermediary”, or “connected inside two elements”. For those of ordinary skill in the art, specific meanings of the preceding terms in the present disclosure may be understood based on specific situations.

Embodiments of the present disclosure are described in detail below. Examples of the embodiments are illustrated in the drawings, where the same or similar reference numerals throughout the drawings represent the same or similar elements or elements having the same or similar functions. The embodiments described below with reference to the drawings are illustrative and intended only to explain the present disclosure and cannot be construed as limiting the present disclosure.

In the integrated electric pump in the related art, the rotor shaft of the electric machine is provided with a cooling channel, and the machine housing is provided with a cooling jacket so that the rotor and the stator of the electric machine can be cooled, respectively, thereby avoiding immersing the stator and the rotor of the electric machine in oil. Compared with the solution of immersing the stator and the rotor of the electric machine in oil, the efficiency can be improved and the sealing requirements for the machine housing can be lowered. However, the oil exchanges heat with the rotor and the stator only through the rotor shaft and the machine housing, resulting in low heat exchange efficiency and affecting the maximum operating power of the electric machine. The direction of improvement just goes from one extreme to another.

In response to this, this embodiment provides an integrated electric pump to solve the preceding technical problems.

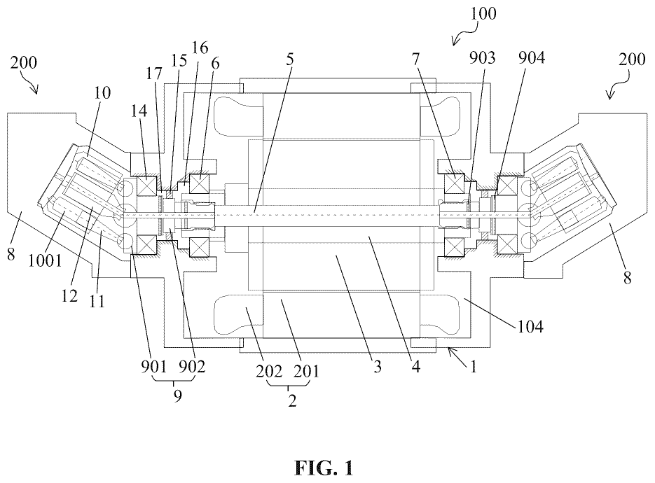

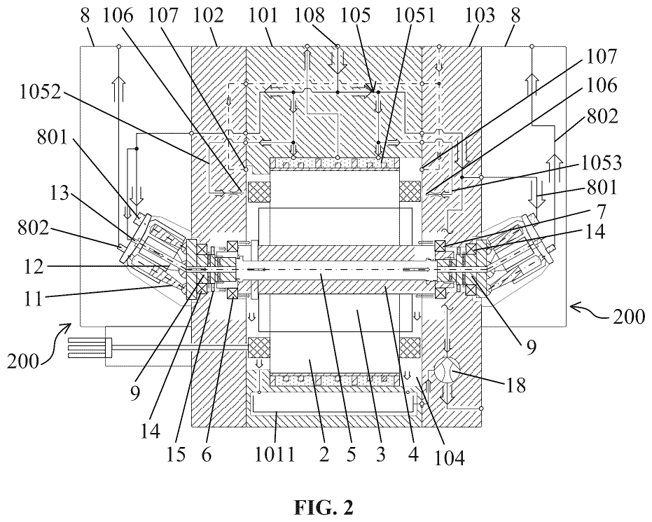

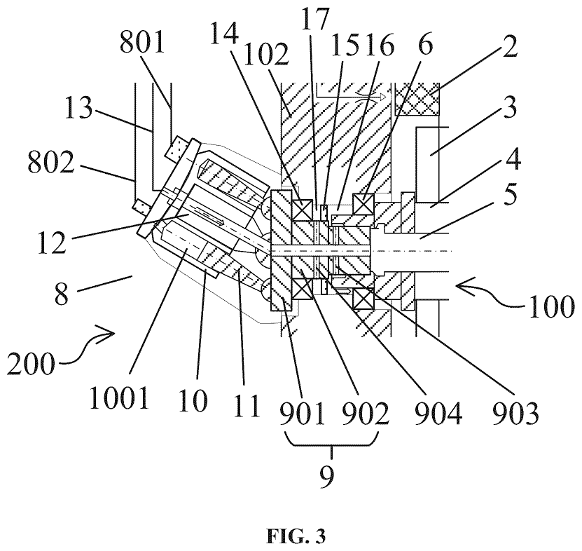

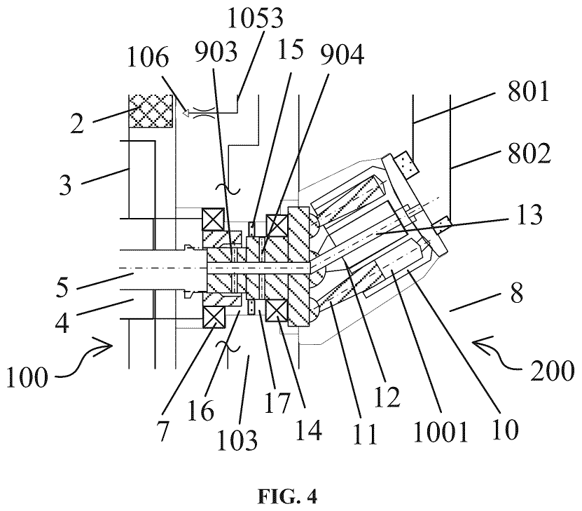

As shown in FIGS. 1 to 4, the integrated electric pump includes an electric machine 100 and pumps, where the electric machine 100 and the pumps are integrated. The electric machine 100 and the pumps are integrated so that the axial dimension of the integrated electric pump can be effectively reduced, the integrated electric pump can be combined with a motor or cylinder, applied to a hydraulic system, and further applied to heavy vehicles, the vehicle exhaust emissions can be effectively reduced, the energy efficiency can be improved, and the vehicle performance can be improved. The pump may be a piston pump 200, a gear pump, or the like. In this embodiment, the case where the pump is the piston pump 200 is used as an example for a specific description.

The electric machine 100 includes a machine housing 1, a stator 2, a rotor 3, and a rotor shaft 4. The machine housing 1 has an inner cavity 104. The stator 2, the rotor 3, and the rotor shaft 4 are disposed in the inner cavity 104. The stator 2 is fixedly disposed in the machine housing 1. The rotor shaft 4 is rotatably disposed in the machine housing 1. The rotor 3 is fixedly disposed on the rotor shaft 4. The stator 2 is sleeved on the rotor 3 with a gap between the stator 2 and the rotor 3. The rotor shaft 4 is provided with a first cooling oil circuit 5. The machine housing 1 is provided with a second cooling oil circuit 105. The rotor shaft 4 is drivingly connected to the pumps. When the electric machine 100 is in operation, heat may be exchanged between the cooling oil in the first cooling oil circuit 5 and the rotor shaft 4, and then heat may be exchanged between the rotor shaft 4 and the rotor 3, thereby lowering the temperature of the rotor 3; and heat may be exchanged between the cooling oil in the second cooling oil circuit 105 and the machine housing 1, and then heat may be exchanged between the machine housing 1 and the stator 2, thereby lowering the temperature of the stator 2. In this manner, the temperature of the stator 2 and the rotor 3 can be lowered to a certain extent.

Moreover, the integrated electric pump further includes an oil discharge pump 18 and multiple spray nozzles 106. The multiple spray nozzles 106 are fixed to the machine housing 1, the spray nozzles 106 are connected to the second cooling oil circuit 105 and are used for spraying cooling oil to the stator 2, and the oil discharge pump 18 is used for discharging the cooling oil in the inner cavity 104 out of the inner cavity 104. In this manner, the cooling oil is sprayed to the stator 2 through the spray nozzles 106, the cooling oil is in direct contact with the stator 2 and can significantly lower the temperature of the stator 2, and the cooling oil may be in contact with the air in the inner cavity 104 to lower the temperature inside the inner cavity 104, thereby cooling the stator 2 and the rotor 3, significantly improving the capacity of cooling the electric machine 100, and ensuring the output power of the electric machine 100. At the same time, the cooling oil in the inner cavity 104 is discharged from the electric machine 100 through the oil discharge pump 18 so that the cooling oil can be prevented from accumulating in the inner cavity 104, it can be ensured that the air gap between the rotor 3 and the stator 2 is filled with air, the power loss of the rotation of the rotor 3 can be reduced or eliminated, and the sealing requirements for the machine housing 1 can be lowered.

Compared with the two extreme methods in the related art of either completely immersing the stator 2 and the rotor 3 of the electric machine 100 in the cooling oil or ensuring that the stator 2 and the rotor 3 of the electric machine 100 are not in contact with the cooling oil, in the electric pump provided in this embodiment, a solution is creatively provided in which the cooling oil is sprayed into the inner cavity 104 of the electric machine 100 and discharged through the oil discharge pump 18 so that the efficiency of the electric machine 100 can be effectively ensured, the output power of the electric machine 100 can be improved, and the sealing requirements for the machine housing 1 can be lowered.

Specifically, the stator 2 includes a stator body 201 and a stator winding 202 disposed on the stator body 201. Along the circumferential direction of the stator 2, two ends of the stator winding 202 extend out of the stator body 201 separately. The multiple spray nozzles 106 are used for spraying cooling oil onto the portions of the stator winding 202 extending out of the stator body 201.

Optionally, the multiple spray nozzles 106 are arranged in an array along the circumferential direction of the stator 2, thereby ensuring uniform cooling of the stator 2.

Optionally, the machine housing 1 is further provided with an oil collection tank 1011, the oil discharge pump 18 is connected to the oil collection tank 1011, the oil collection tank 1011 is connected to the inner cavity 104, and the connection point between the oil collection tank 1011 and the inner cavity 104 is located at the lowest point of the inner cavity 104. In this manner, the cooling oil sprayed into the inner cavity 104 may eventually flow into the oil collection tank 1011 under the action of gravity and be discharged from the inner cavity 104 through the oil discharge pump 18. It is to be understood that the total flow rate of the cooling oil sprayed into the inner cavity 104 is not greater than the pumping volume of the oil discharge pump 18, thereby ensuring that the cooling oil does not accumulate in the inner cavity 104.

Optionally, the integrated electric pump further includes multiple gas jet nozzles 107 which are disposed in the machine housing 1, connected to the inner cavity 104, and used for spraying compressed gas into the inner cavity 104. In this manner, on the one hand, it can be ensured that the air gap between the rotor 3 and the stator 2 is filled with air, thereby preventing the air gap between the rotor 3 and the stator 2 from being immersed in oil; on the other hand, under the action of compressed gas, it is conducive to the flow of the oil in the oil collection tank 1011 to the oil discharge pump 18. The oil discharge pump 18 in this embodiment is specifically a jet pump. The jet pump has a jet inlet, a suction port, and a jet outlet. The jet inlet is used for inputting oil, and the suction port is used for connecting with the oil collection tank 1011. In other embodiments, the oil discharge pump 18 may be of another type as required.

Optionally, the piston pump 200 includes a pump housing 8, a cylinder body 10, a pump shaft 9, multiple first pistons 11, and a second piston 12. Pump housings 8 are fixedly disposed on the machine housing 1. The cylinder body 10 is rotatably disposed in the pump housing 8, and the cylinder body 10 is provided with multiple piston chambers 1001. The pump shaft 9 includes a connection end 901 and a connecting shaft 902 fixedly connected to the connection end 901, the connecting shaft 902 is rotatably disposed in the machine housing 1, and the connecting shaft 902 and the rotor shaft 4 are splined. The multiple first pistons 11 are slidably disposed in the multiple piston chambers 1001 in one-to-one correspondence. A first ball head is provided at an end of the first piston 11 and spherically hinged with the connection end 901. The multiple first pistons 11 are evenly distributed along the circumferential direction of the second piston 12. A second ball head is provided at an end of the second piston 12 and spherically hinged with the connection end 901, and the centerline of the second piston 12 is disposed at an included angle to the centerline of the pump shaft 9. When the electric machine 100 is started, through the connecting shaft 902, the rotor shaft 4 drives the pump shaft 9 to rotate to drive the cylinder body 10 to rotate, thereby simultaneously driving the multiple first pistons 11 to reciprocate in the piston chambers 1001 and achieving oil suction and pumping. The connecting shaft 902 and the rotor shaft 4 are splined so that the connecting shaft 902 and the rotor shaft 4 can be decoupled in the axial direction, thereby minimizing the impact of the large force generated by the pump on the performance of the electric machine 100. Further optionally, the connecting shaft 902 and the connection end 901 are integrally provided.

It is to be understood that the integrated electric pump is further provided with a pump inlet oil circuit 801 connected to an input end of the piston pump 200 and a pump outlet oil circuit 802 connected to an output end of the piston pump 200. When the electric machine 100 drives the piston pump 200 to work, the piston pump 200 can suck oil from the pump inlet oil circuit 801 and pump the oil out from the pump outlet oil circuit 802.

Optionally, the electric machine 100 can rotate in the forward direction and the reverse direction. Specifically, when the electric machine 100 rotates in the forward direction, the piston pump 200 sucks oil from the pump inlet oil circuit 801 and pumps the oil out from the pump outlet oil circuit 802; when the electric machine 100 rotates in the reverse direction, the piston pump 200 sucks oil from the pump outlet oil circuit 802 and pumps the oil out from the pump inlet oil circuit 801.

Optionally, the integrated electric pump is further provided with an oil inlet circuit 13 passing through the pump housing 8, the cylinder body 10, the second piston 12, and the pump shaft 9 in sequence and connected to the first cooling oil circuit 5. Such a configuration helps the cooling oil enter the rotor shaft 4 through the piston pump 200. The center of the second ball head of the second piston 12 is located on the rotating centerline of the pump shaft 9.

Optionally, the integrated electric pump further includes a first bearing 6 and a second bearing 7 arranged at intervals, the inner race of the first bearing 6 and the inner race of the second bearing 7 are fixedly sleeved on two ends of the rotor shaft 4, respectively, and the outer race of the first bearing 6 and the outer race of the second bearing 7 are both fixedly disposed in the machine housing 1. The rotor shaft 4 may be rotatably supported by the first bearing 6 and the second bearing 7. The first bearing 6 and the second bearing 7 are preferably cylindrical roller bearings. Specifically, during the operation of the electric machine 100, the axial force borne by the rotor shaft 4 is minimal, but at a specific operating point, the radial force may become very large, so for load-bearing purposes, the rotor shaft 4 needs to be supported by two bearings.

Specifically, the machine housing 1 includes a cylindrical housing 101 in a tubular shape, a first end housing 102, and a second end housing 103. The first end housing 102 and the second end housing 103 are located at two ends of the cylindrical housing 101. The first bearing 6 is disposed in the first end housing 102. The second bearing 7 is disposed in the second end housing 103. The pump housing 8 is connected to the first end housing 102. The connecting shaft 902 is rotatably disposed in the first end housing 102. In this manner, the electric machine 100 and the piston pump 200 can share the first end housing 102, thereby reducing the axial dimension of the integrated electric pump.

Optionally, the second cooling oil circuit 105 includes a cooling jacket oil circuit 1051 provided in the cylindrical housing 101, a first oil spraying circuit 1052 provided in the first end housing 102, and a second oil spraying circuit 1053 provided in the second end housing 103. The inner surface of the cylindrical housing 101 is provided with multiple heat dissipation fins. The cooling oil in the cooling jacket oil circuit 1051 is used for heat exchange with the heat dissipation fins. The heat dissipation fins are embedded in the stator 2. The heat generated by the stator 2 is transferred to the heat dissipation fins and taken away by the cooling oil in the cooling jacket oil circuit 1051, thereby cooling the stator 2. Both the first end housing 102 and the second end housing 103 are provided with multiple spray nozzles 106. The multiple spray nozzles 106 provided in the first end housing 102 are all first spray nozzles, and the multiple spray nozzles 106 provided in the second end housing 103 are all second spray nozzles. The multiple first spray nozzles are evenly distributed along the circumferential direction of the stator 2, are all connected to the first oil spraying circuit 1052, and are all used for spraying the cooling oil to the portion of an end of the stator winding 202 extending out of the stator body 201; and the multiple second spray nozzles are evenly distributed along the circumferential direction of the stator 2, are all connected to the second oil spraying circuit 1053, and are all used for spraying the cooling oil to the portion of the other end of the stator winding 202 extending out of the stator body 201, thereby ensuring sufficient cooling of the stator winding 202.

Optionally, the piston pump 200 further includes a third bearing 14, the first bearing 6 is located between the third bearing 14 and the second bearing 7, the inner race of the third bearing 14 is fixedly sleeved on the connecting shaft 902, the outer race of the third bearing 14 is fixed to the machine housing 1, the rotor shaft 4 is provided with a spline groove, the connecting shaft 902 is provided with spline teeth, the spline teeth are inserted into the spline groove, and the first bearing 6 is also sleeved on the connecting shaft 902. In this manner, the piston pump 200 and the electric machine 100 can share the first bearing 6, which is conducive to further reducing the axial dimension of the integrated electric pump. Specifically, most of the radial load generated by the piston pump 200 may be borne by the third bearing 14, a small part of the radial load is transmitted to the rotor shaft 4 through the spline and further transmitted to the first bearing 6, and this part of the load does not affect the performance of the electric machine 100. Preferably, the first bearing 6 is a tapered roller bearing, thereby effectively bearing the radial load.

Optionally, the piston pump 200 further includes a shaft seal 15 located between the first bearing 6 and the third bearing 14. The shaft seal 15 is sleeved on the connecting shaft 902 and sealingly mates with the connecting shaft 902. The shaft seal 15 is in sealing contact with the machine housing 1. In this manner, the piston pump 200 can be sealed by the shaft seal 15, thereby preventing oil from entering the electric machine 100 from the piston pump 200. A first oil chamber 16 is formed between the shaft seal 15 and the first bearing 6, and a second oil chamber 17 is formed between the shaft seal 15 and the third bearing 14.

Optionally, the connecting shaft 902 is further provided with a first lubricating oil circuit 903 connected to the oil inlet circuit 13, and the first lubricating oil circuit 903 is connected to the first oil chamber 16 so that the first bearing 6 can be lubricated by the oil flowing out through the first lubricating oil circuit 903. In this embodiment, the oil in the first oil chamber 16 can flow into the inner cavity 104 after lubricating the first bearing 6.

It is to be noted that the number of first lubricating oil circuits 903 may be set as required. For example, one or multiple first lubricating oil circuits 903 may be provided, and the multiple first lubricating oil circuits 903 may be evenly arranged along the axis of the connecting shaft 902. In addition, the first lubricating oil circuit 903 may extend along the radial direction of the connecting shaft 902 or may be set at an included angle to the radial direction of the connecting shaft 902.

Optionally, the connecting shaft 902 is further provided with a second lubricating oil circuit 904 connected to the oil inlet circuit 13, and the second lubricating oil circuit 904 is connected to the second oil chamber 17 so that the third bearing 14 can be lubricated by the oil flowing out through the second lubricating oil circuit 904. It is to be noted that the oil in the second oil chamber 17 can flow into the piston pump 200 after lubricating the third bearing 14.

It is to be noted that the number of second lubricating oil circuits 904 may also be set as required. For example, one or multiple second lubricating oil circuits 904 may be provided, and the multiple second lubricating oil circuits 904 may be evenly arranged along the axis of the connecting shaft 902. In addition, the second lubricating oil circuit 904 may extend along the radial direction of the connecting shaft 902 or may be set at an included angle to the radial direction of the connecting shaft 902.

Optionally, the integrated electric pump includes two piston pumps 200 disposed at two ends of the electric machine 100, respectively, and two ends of the rotor shaft 4 are splined to connecting shafts 902 of the two piston pumps 200, respectively. At least one piston pump 200 is provided with the oil inlet circuit 13. The first bearing 6 and the second bearing 7 are both located between the third bearings 14 of the two piston pumps 200. In this manner, both the first bearing 6 and the second bearing 7 can be effectively cooled and lubricated. Of course, the integrated electric pump may include only one piston pump 200 as required.

Optionally, the two piston pumps 200 are symmetrically disposed at two ends of the electric machine 100 so that the overall structure of the integrated electric pump is compact.

Optionally, the integrated electric pump further includes an oil input port 108. In this embodiment, the oil input port 108 is connected to pump inlet oil circuits 801 of the two piston pumps 200 separately so that oil can enter the two piston pumps 200 through a common oil port. In other embodiments, the pump inlet oil circuits 801 of the two piston pumps 200 may be separately connected to an external oil source, thereby achieving separate oil supplies. Preferably, the integrated electric pump further includes an oil output port (not shown in the drawings) connected to pump outlet oil circuits 802 of the two piston pumps 200 separately so that the two piston pumps 200 can pump oil out through a common oil port. In other embodiments, the pump outlet oil circuits 802 of the two piston pumps 200 can pump oil out through separate oil ports.

Optionally, the oil input port 108 may be connected to one or more of the oil inlet circuit 13, the cooling jacket oil circuit 1051, the first oil spraying circuit 1052, the second oil spraying circuit 1053, or the jet inlet of the jet pump. In this embodiment, the following solution is provided as an example in which the oil input port 108 is connected to the oil inlet circuit 13, the cooling jacket oil circuit 1051, the first oil spraying circuit 1052, the second oil spraying circuit 1053, and the jet inlet of the jet pump at the same time. When the oil input port 108 is connected to part of the pump inlet oil circuit 801 of the piston pump 200, the oil inlet circuit 13, the cooling jacket oil circuit 1051, the first oil spraying circuit 1052, the second oil spraying circuit 1053, and the jet inlet of the jet pump, the other part of the pump inlet oil circuit 801 of the piston pump 200, the oil inlet circuit 13, the cooling jacket oil circuit 1051, the first oil spraying circuit 1052, the second oil spraying circuit 1053, and the jet inlet of the jet pump may be supplied with oil separately through the external oil source.

This embodiment further provides a vehicle. The vehicle includes the integrated electric pump in the preceding solution, where the integrated electric pump and a hydraulic motor of the vehicle form a closed hydraulic system loop.

What is claimed is:

1. An integrated electric pump, comprising an electric machine and a pump, wherein the electric machine and the pump are integrated, the electric machine comprises a machine housing, a stator, a rotor, and a rotor shaft, wherein the machine housing has an inner cavity, the stator, the rotor, and the rotor shaft are disposed in the inner cavity, the stator is fixedly disposed in the machine housing, the rotor shaft is rotatably disposed in the machine housing, the rotor is fixedly disposed on the rotor shaft, the stator is sleeved on the rotor with a gap between the stator and the rotor, the rotor shaft is provided with a first cooling oil circuit, the machine housing is provided with a second cooling oil circuit, and the rotor shaft is drivingly connected to the pump; wherein the integrated electric pump further comprises:
a plurality of spray nozzles fixed to the machine housing, wherein the plurality of spray nozzles are connected to the second cooling oil circuit and are used for spraying cooling oil to the stator; and
an oil discharge pump for discharging cooling oil in the inner cavity out of the inner cavity.

2. The integrated electric pump of claim 1, wherein the machine housing is further provided with an oil collection tank, the oil discharge pump is connected to the oil collection tank, the oil collection tank is connected to the inner cavity, and a connection point between the oil connection tank and the inner cavity is located at a lowest point of the inner cavity.

3. The integrated electric pump of claim 1, further comprising a plurality of gas jet nozzles that are disposed in the machine housing, connected to the inner cavity, and used for spraying compressed gas into the inner cavity.

4. The integrated electric pump of claim 1, further comprising a first bearing and a second bearing arranged at intervals, wherein an inner race of the first bearing and an inner race of the second bearing are fixedly sleeved on two ends of the rotor shaft, respectively, and an outer race of the first bearing and an outer race of the second bearing are both fixedly disposed in the machine housing.

5. The integrated electric pump of claim 4, wherein the pump is a piston pump, wherein the piston pump comprises:
a pump housing fixedly disposed on the machine housing;
a cylinder body rotatably disposed in the pump housing, wherein the cylinder body is provided with a plurality of piston chambers;
a pump shaft comprising a connection end and a connecting shaft fixedly connected to the connection end, wherein the connecting shaft is rotatably disposed in the machine housing, and the connecting shaft and the rotor shaft are splined;
a plurality of first pistons slidably disposed in the plurality of piston chambers in one-to-one correspondence, wherein a first ball head is disposed at an end of each of the plurality of first pistons and spherically hinged with the connection end; and
a second piston, wherein the plurality of first pistons are evenly distributed along a circumferential direction of the second piston, a second ball head is provided at an end of the second piston and spherically hinged with the connection end, and a centerline of the second piston is disposed at an included angle to a centerline of the pump shaft.

6. The integrated electric pump of claim 5, wherein the piston pump further comprises a third bearing, wherein the first bearing is located between the third bearing and the second bearing, and an inner race of the third bearing is fixedly sleeved on the connecting shaft; and
the machine housing comprises a cylindrical housing in a tubular shape, a first end housing, and a second end housing, the first end housing and the second end housing are connected to two ends of the cylindrical housing, the cylindrical housing, the first end housing, and the second end housing enclose to form the inner cavity, the connecting shaft is rotatably disposed in the first end housing, the outer race of the first bearing and an outer race of the third bearing are both fixedly disposed in the first end housing, and the outer race of the second bearing is fixedly disposed in the second end housing.

7. The integrated electric pump of claim 6, wherein the rotor shaft is provided with a spline groove, the connecting shaft is provided with spline teeth, the spline teeth are inserted into the spline groove, and the first bearing is also sleeved on the connecting shaft.

8. The integrated electric pump of claim 6, wherein the piston pump further comprises a shaft seal located between the first bearing and the third bearing, the shaft seal is sleeved on the connecting shaft and sealingly mates with the connecting shaft, the shaft seal is in sealing contact with the machine housing, a first oil chamber is formed between the shaft seal and the first bearing, and a second oil chamber is formed between the shaft seal and the third bearing.

9. The integrated electric pump of claim 8, wherein the piston pump is further provided with an oil inlet circuit passing through the pump housing, the cylinder body, the second piston, and the pump shaft in sequence and connected to an end of the first cooling oil circuit.

10. The integrated electric pump of claim 9, wherein the connecting shaft is further provided with a first lubricating oil circuit connected to the oil inlet circuit, and the first lubricating oil circuit is connected to the first oil chamber.

11. The integrated electric pump of claim 9, wherein the connecting shaft is further provided with a second lubricating oil circuit connected to the oil inlet circuit, and the second lubricating oil circuit is connected to the second oil chamber.

12. The integrated electric pump of claim 9, comprising two piston pumps disposed at two ends of the electric machine, respectively, wherein the two ends of the rotor shaft are splined to connecting shafts of the two piston pumps, respectively, and at least one of the two piston pumps is provided with the oil inlet circuit.

13. The integrated electric pump of claim 10, comprising two piston pumps disposed at two ends of the electric machine, respectively, wherein the two ends of the rotor shaft are splined to connecting shafts of the two piston pumps, respectively, and at least one of the two piston pumps is provided with the oil inlet circuit.

14. The integrated electric pump of claim 11, comprising two piston pumps disposed at two ends of the electric machine, respectively, wherein the two ends of the rotor shaft are splined to connecting shafts of the two piston pumps, respectively, and at least one of the two piston pumps is provided with the oil inlet circuit.

15. The integrated electric pump of claim 1, wherein the electric machine is rotatable in a forward direction and a reverse direction.

16. The integrated electric pump of claim 2, wherein the electric machine is rotatable in a forward direction and a reverse direction.

17. The integrated electric pump of claim 3, wherein the electric machine is rotatable in a forward direction and a reverse direction.

18. The integrated electric pump of claim 4, wherein the electric machine is rotatable in a forward direction and a reverse direction.

19. The integrated electric pump of claim 5, wherein the electric machine is rotatable in a forward direction and a reverse direction.

20. A vehicle, comprising a hydraulic motor or cylinder and the integrated electric pump of claim 1, wherein the integrated electric pump and a hydraulic motor or cylinder of the vehicle form a closed hydraulic system loop.
